(19) United States
(12) Patent Application Publication
(10) Pub. No.: US 2010/0041820 A1
(43) Pub. Date: Feb. 18, 2010

(54) Resin and Paint Coating Compositions Comprising Highly Esterified Polyol Polyesters with Two or More Pairs of Conjugated Double Bonds

(76) Inventors: Delano R. Eslinger, Smithville, MO (US); Dennis A. Ryer, Kansas City, MO (US); Neal Rogers, Kansas City, MO (US); Roger S. Berger, Fairfield, OH (US); Deborah J. Back, Cleves, OH (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 12/537,448

(22) Filed: Aug. 7, 2009

Related U.S. Application Data
(60) Provisional application No. 61/089,681, filed on Aug. 18, 2008.

(51) Int. Cl. C08G 63/02; C08L 67/00

(52) U.S. Cl. 524/539; 525/451

(57) ABSTRACT

An alkyd resin comprising A) a polyol-polyacid alkyd; and B) a composition comprising a highly esterified polyol polyester wherein the polyester comprises a polyol residue and a plurality of fatty acids esters, and wherein from about 2% to about 55% of the fatty acid esters contains two or more pairs of conjugated double bonds.

### CROSS-REFERENCE TO RELATED APPLICATIONS

This application claims priority to U.S. Provisional Application Ser. No. 61/089,681, filed Aug. 18, 2008.

### FIELD OF THE INVENTION

The disclosure herein relates to a new alkyd resin or alkyd resin composition (both having the same meaning hereafter) comprising a polyol polyester composition for use as a multifunctional non-volatile component in alkyd-based paint and/or related coating compositions. More particularly the disclosure relates to the presence in the alkyd resin of a highly esterified polyol polyester having conjugated ester side chains.

Volatile organic compounds (VOCs) are organic chemical compounds that have vapor pressures under normal conditions that are sufficiently high to allow them to vaporize and easily enter the atmosphere. Typical VOCs are light hydrocarbons such as paint thinner or gasoline. Many VOCs are applied in industrial uses including the manufacture and application of polymeric coatings, resins, or finished coatings.

Considerable effort has been expended in recent years to develop coating compositions that require low VOC content due to environmental hazards associated with VOCs. The level of VOC content for architectural and industrial maintenance coatings, for example, is limited by regulation. The regulatory restrictions have encouraged research and development to explore new technologies directed at reducing typical VOC solvent emissions from the application of coatings in a variety of industries.

European Patent EP 1470200B1 has previously disclosed the concept of replacing volatile solvents in paint and resin applications with reactive diluents. Reactive diluents reduce the viscosity of the paint during application but are subsequently incorporated into the polymeric network coat upon drying. EP 1470200B1 teaches the use of fatty acid modified carbohydrates as reactive diluents. However, while EP 1470200B1 teaches the value of fatty acid modified carbohydrates as achieving desired lower viscosity, low VOC resins and paints, the resulting paints and resins are uncontrolled in drying performance. Paints and resins incorporating many of the fatty acid modified carbohydrates of EP 1470200, including the exemplified compositions exhibit unacceptable drying profiles. That is, they either take much too long to dry or dry so fast that the coatings obtain insufficient adhesion to the coated surface.

It has now been surprisingly discovered that a modified form of a highly esterified polyol polyester developed as a replacement for shortening in foods provides excellent and unexpected benefits as a major component or additive in traditional solvent borne alkyd resins and subsequent paint and resin compositions. Specifically, modified forms of the polyol polyesters described in U.S. Pat. No. 5,021,256 have been found to act as a non-volatile solvent that provides optimal viscosity control of alkyd resins compositions and paint formulations enabling full or partial replacement of traditionally used volatile solvents. The disclosed polyol polyesters may also be used as a reactive film-former that provides for a low viscosity liquid form upon making and in storage, but that dries in a controlled manner. Without being bound by theory, Applicants believe that the polyol polyesters work synergistically with alkyd resin and other constituents of a coating when undergoing auto-oxidative polymeric cross-linking. This allows for enhanced surface adhesion and film properties.

### SUMMARY OF THE INVENTION

Described herein is an alkyd resin or alkyd resin composition which comprises a highly esterified polyol polyester. The polyol polyester comprises a polyol residue and a plurality of fatty acid ester groups where from about 2% to about 55%, or preferably from about 5% to about 30%, or more preferably from about 7% to about 20% by weight, of the fatty acid esters contain two or more pairs of conjugated double bonds. Also described herein are alkyd resins and other coating compositions comprising the new polyol polyester, with solvent-like properties, taking the place of VOC solvents, in storage in its liquid state, and forming a coating with other active constituents of the material with which it is used upon drying. Further, the polyol polyester described herein may be used to control the drying times upon application to a surface.

Thus, a first embodiment of the present invention relates to an alkyd resin modified by the presence of a specific polyol polyester as a low viscosity component, which polyester comprises a polyol residue and a plurality of fatty acids esters from which esters, 2% to about 55%, or preferably from about 5% to about 30%, or more preferably from about 7% to about 20% by weight, contain two or more pairs of conjugated double bonds.

According to a second embodiment, the polyester composition may comprise two or more highly esterified polyol polyesters where from about 2% to about 55%, or preferably from about 5% to about 30%, or more preferably from about 7% to about 20% by weight of the total fatty acid esters in the compositions, contain two or more pairs of conjugated double bonds. In one or more embodiments of the composition of the invention, the polyol residue may be selected from the group consisting of sugars and sugar alcohols. Each polyol may have an average esterification of the available hydroxyl groups of at least about 50%, preferably from about 70% to 100%, and more preferably from about 85% to 100%.

Also described are compositions comprising a highly esterified polyol polyester comprising a polyol residue and a plurality of fatty acid ester groups wherein the polyol has been esterified by the reaction with one or more fatty acid methyl ester derived from a material selected from the group consisting of soybean oil, safflower oil, sunflower oil, castor oil, dehydrated castor oil, lesquerella oil, dehydrated lesquerella oil, linseed oil, flaxseed oil, cottonseed oil, tall oil, canola oil, corn oil, olive oil, palm olien, tung oil, and combinations thereof, in relative amounts sufficient to have from about 2% to about 55%, or preferably from about 5% to about 30%, or more preferably from about 7% to about 20% by weight of the fatty acid ester groups containing two or more pairs of conjugated double bonds.

Another embodiment of the present invention relates to a coating composition, preferably a paint composition, comprising at least one alkyd resin as defined according to the two embodiments described above, the first embodiment with one and the second embodiment with two or more highly esterified polyol polyester in the polyester composition.

### DETAILED DESCRIPTION OF THE INVENTION

### Highly Esterified Polyol Polyester

The present invention relates to an alkyd resin or alkyd resin composition (alkyd resin meaning the same) comprising:
A) a polyol-polyacid alkyd; and
B) a composition comprising a highly esterified polyol polyester comprising a polyol residue and a plurality of fatty acid ester groups wherein from about 2% to about 55%, or preferably from about 5% to about 30%, or more preferably from about 7% to about 20% by weight, of the fatty acid ester groups contain two or more pairs of conjugated double bonds.

The term “polyol” as used herein means a polyhydric alcohol containing four or more hydroxyl groups. Examples include, without limitation, sugars and sugar alcohols, sorbitol, glycol and others. Triglycerides having three hydroxyl groups are excluded from the term “polyol” as used herein. The term “polyol residue” as used herein means the core of the polyol molecule after one or more of the polyol hydroxyl groups have been reacted (converted) into an ester group.

Example polyols for preparing the polyol polyesters for use in the present invention are those having at least four hydroxy groups, or esterification sites to which the fatty acids are covalently bound. In one or more embodiments of the composition of the invention, the polyol may be selected from the group consisting of sugars and sugar alcohols. Selected embodiments of the present polyol polyester comprise a polyol residue selected from the group consisting of adonitol, arabitol, sorbitol, mannitol, galactitol, isomalt, lactitol, xylitol, maltitol, 1-methyl-glucopyranoside, 1-methyl-galactopyranoside, 1-methyl-mannopyranoside, dextrin, erythritol, pentaerythritol, diglycerol, polyglycerol, sucrose, amylose, nystose, kestose, trehalose, raffinose, gentianose and mixtures thereof. Certain embodiments utilize polyols selected from the group consisting of xylitol, sorbitol, glucose and sucrose, with sorbital and sucrose preferred. Sucrose is more preferred in some embodiments.

The highly esterified polyol polyester comprises a plurality of fatty acid ester groups. As used herein, “highly esterified” means a structure condition wherein at least 50% of the available hydroxyl groups of a polyol have been esterified. Specific embodiments of highly esterified polyol polyesters may have an average esterification of at least about 50%, preferably from about 50 to 100% more preferably from about 70% to 100%, or even more preferably from about 85% to about 100% of the available hydroxyl groups, to be esterified. The plurality of fatty acid ester groups of the polyol polyester may comprise one or more fatty acids selected from the group consisting of anteisoarachadic, behenic, bosseopentaenoic acid, calendic, capric, caprylic, catalpic, eicosadienoic, eleostearic, erydiogenic, isomargaric, isomyristic, isostearic, jacaric, lauric, lesquerolic, licanic, linoleic, linolenic, myristic, oleic, palmitic, parinaric, punicic, ricinoleic, ricinenic, rumenic, rumelenic, and stearic acids. In some embodiments of the polyol polyester, the fatty acids are selected from the group consisting of stearic acid, oleic acid, linoleic acid, linolenic acid, eleostearic acid, ricinoleic, conjugated linoleic acid, rumenic acid and mixtures thereof. The fatty acids can be derived from naturally occurring oils or from synthetic fatty acids derived from oils; they can be saturated or unsaturated, including positional and geometrical isomers (e.g., cis and trans isomers). The fatty acids esterified to the polyol molecule may be mixed fatty acids to produce the desired physical properties

The polyol polyester of the present invention comprises fatty acid ester groups wherein from about 2% to about 55%, or preferably from about 5% to about 30%, or more preferably from about 7% to about 20% of the fatty acid esters contain two or more pairs of conjugated double bonds. As used herein a “pair of conjugated double bonds” means two double bonds in an unsaturated carbon chain that are non-methylene interrupted. As such the chemical structure of the conjugated double bond is —C═C—C═C— where the two C═C groups are separated by only one single bond. “Conjugated fatty acids” as used herein means a fatty acid containing conjugated double bonds, such as polyunsaturated fatty acids in which at least one pair of double bonds are non-methylene interrupted. Conjugated fatty acids having two or more pairs of conjugated double bonds include calendic or jacaric acids (both isomers of 8,10,12-octadecatrienoic acid), catalpic, eleostearic or punicic acids (all isomers of 9,11,13-octadeca trienoic acid), parinaric acid (9,11,13,15-octadecatetraenoic acid), and bosseopentaenoic acid (5,8,10,12,14-eicosapentaenoic acid). Example embodiments of the polyol polyester may comprise from about 2% to about 20% of an eleostearic acid.

It has been found that in order to achieve the drying control required for consumer acceptance of paints and coatings the polyol polyester must contain at least about 2% of fatty acid esters containing two or more pairs of conjugated double bond in order to get the drying acceleration provided by the selected esters. Further, the polyol polyester must not contain over 55% of the fatty acid esters containing two or more pairs of conjugated double bonds for above such levels uncontrolled drying acceleration results in non-homogeneous drying and lack of adhesion of the coating layer.

Specific, but non-limiting, examples of polyol fatty acid polyesters suitable for use herein are polyol polyester compositions made by esterifying sucrose with a single fatty acid or source of fatty acids, or a blend of either, in relative amounts sufficient to provide from about 2% to about 55% of the ester fatty acids which contain two or more pairs of conjugated double bonds. In various embodiments, a preferred highly-esterified sucrose has an average distribution of fatty acid esters on the sucrose backbone of 6 to 8, and preferably from 7 to 7.5, wherein the fatty acid moieties each contain preferably from 12 to 22 carbon atoms and most preferably contain primarily 18 carbon atoms. Fatty acids of different carbon length can be used.

One embodiment of the composition of the present invention comprises a polyol polyester composition that includes one or more sucrose polyesters, each having an average esterification of about 7-7.5 with tung oil which comprises approximately 80% conjugated eleostearic acid.

The polyol polyesters described herein can be prepared by a variety of general synthetic methods known to those skilled in the art, including but not limited to, transesterification of the polyol with the desired fatty acid esters and any of a variety of suitable catalysts, acylation of the polyol with a fatty acid chloride, acylation of the polyol with a fatty acid anhydride, and acylation of the polyol with a fatty acid. The preparation of polyol fatty acid polyesters is described in U.S. Pat. No. 6,121,440. The preparation of polyol fatty acid esters is described in U.S. Pat. Nos. 4,518,772; 4,517,360; and 3,963,699.

In general, the polyol polyester is made by reaction of a polyol with a fatty acid methyl ester derived from suitable source oil in the presence of fatty acid soap, for example potassium stearate, and an alkaline catalyst, preferably potassium carbonate. The reaction is driven to completion at a temperature of from about 115 to about 135° C., preferably 135° C., by removal of methanol from the reaction. Methanol removal is assisted by the application of a nitrogen sparge and/or vacuum distillation at from about 1 to about 760 mm Hg pressure. The crude polyol polyester is further processed to remove the excess soap via hydration/centrifugation. Decolorization of the crude oil mixture is achieved via bleaching earth addition followed by mixing and filtration. Removal of excess fatty acid methyl ester is then accomplished by vacuum distillation.

Alternatively, the polyol polyester can be made by the reaction of polyol and fatty acid chloride which is derived from suitable source oil, in a solvent mixture consisting of pyridine and N,N-dimethylformamide at a temperature of from about 40 to about 80° C. An excess of pyridine is used in order to complex HCl which is formed during the esterification. The desired polyol polyester is then isolated by extraction into solvent followed by water washing. The organic layer is separated and dried over MgSO₄, then filtered to remove the solids. The solvent is removed via vacuum distillation using a rotary evaporator. The polyol polyester is then extracted several times with methanol to remove any residual fatty acid, and then dried of solvent using a rotary evaporator.

Another method of preparation uses a solvent, preferably N,N-dimethylacetamide, to react the polyol and fatty acid methyl ester derived from suitable source oil. This method uses alkaline catalysis, preferably potassium carbonate, and the reaction is carried out at a temperature of about 120° C. under reduced pressure, preferably from about 15 to about 20 mm Hg. Upon completion of the reaction the excess solvent is distilled off at reduced pressure, for example at a pressure of less than about 1 mm Hg. The polyol polyester is then extracted into solvent, preferably hexanes or petroleum ether, and water washed. The organic phase is isolated and then washed with methanol to remove any residual fatty acid methyl ester. The solvent is then removed via vacuum distillation.

Embodiments of the polyol polyester can be prepared by esterification reaction of a polyol with one or more fatty acid methyl esters derived from a material selected from the group consisting of soybean oil, safflower oil, sunflower oil, castor oil, dehydrated castor oil, lesquerella oil, dehydrated lesquerella oil, linseed oil, flaxseed oil, cottonseed oil, tall oil, canola oil, corn oil, olive oil, palm olien, tung oil, and combinations thereof, in relative amounts sufficient to have from about 2% to about 55%, preferably from about 5% to about 30%, or more preferably from about 7% to about 20% by weight of the fatty acid esters in the polyol polyester containing two or more pairs of conjugated double bonds. One embodiment of the polyester may have an average esterification of from about 70% to 100% formed by a process of esterifying sucrose with a blend of fatty acid methyl esters derived from oils comprising soybean oil, tung oil and mixtures thereof. Another embodiment may be a sucrose polyester having an average esterification of from about 70% to 100% formed by a process of esterifying sucrose with a blend of fatty acid methyl esters derived from oils comprising of from about 3% to about 60% tung oil and from greater than about 40% to about 97% soybean oil. Yet another embodiment may include a sucrose polyester esterified with a blend of fatty acid methyl esters derived from oils comprising from about 5% to about 20% tung oil and from about 80% to about 95% soybean oil. For purposes of clarity, the oils may be blended prior to forming a fatty acid methyl ester blend, or alternatively, the fatty acid methyl esters may be formed from separate oils, and then combined to form a fatty acid methyl ester blend.

In an embodiment of the composition of the present invention, the polyol polyester may be a sucrose polyester having an average esterification of from about 6 to about 7.5 or from about 7 to about 7.5 esterified with a blend of fatty acid methyl esters derived from tung oil and soybean oil such that the blend has the proper conjugation within the fatty acid chains. The blend may comprise as little as about 3% tung oil which results in about 2.4% of an eleostearic acid (C18:3), or other conjugated fatty acid, content going into the esterification step. Alternatively, sucrose polyesters having an average esterification of about 6 may be used.

### Paint and Resin Products

The polyol polyester compositions of the present invention show improved drying benefits as a low VOC, low viscosity component when incorporated into paint and resin coatings. As defined above the present invention relates to an alkyd resin composition comprising the highly esterified polyol polyester described herein and a polyol-polyacid alkyd.

The polyol-polyacid alkyd as a component A) of the alkyd resin composition is a reaction product of:
a) from about 10% to about 40%, preferably from about 15% to about 30% by weight of a polyol;
b) from 0 to about 40%, preferably from about 10% to about 30% by weight, of a polyacid, an acid anhydride or combination thereof; and
c) from about 25% to about 80%, preferably from about 35% to about 70%, more preferably from about 40% to about 60% by weight, of fatty acids, fatty acid derivatives of oils, or combination thereof.

Alkyd resins are long established binders for film coating compositions. Alkyds are in general the reaction product of the esterification of polyhydric alcohols with polybasic acids or their anhydrides and fatty acids or glycerol ethers thereof. The properties of the alkyds are primarily determined by the nature and the ratios of the alcohols and acids used and by the degree of condensation. For example alkyd resins are generally grouped by their “oil length”. An alkyd having from about 30% to about 40% fatty acid or oil content is know as a “short oil”. An alkyd having from about 40 to about 55% fatty acid content is known as a “medium oil”. An alkyd having greater than about 55% fatty acid content is known as a “long oil”.

The alkyd resin of the present invention may comprise from about 10% to about 40%, or preferably from about 15% to about 30% by weight of the alkyd resin, of a polyhydric alcohol, or polyol. The polyols of the alkyd resin include without limitation, glycerol, pentaerythritol, dipentaerythritol, trimethylolethane, trimethylolpropane, ethylene glycol, propylene glycol, neopentylene glycol and dipropylene glycol and combinations thereof. The polybasic acids, or “polyacids”, or their anhydrides may be comprised in the alkyd resin at levels ranging from 0% to about 40%, or preferably from about 10% to about 30%, by weight of the alkyd resin. The polyacids and anhydrides may include, without limitation, isophthalic acid, terephthalic acid, chlorendic anhydride, tetrahydrophthalic anhydride, hexa hydrophthalic anhydride, phthalic anhydride, maleic anhydride, fumaric acid, azelaic acid, succinic acid, adipic acid, sebacic acid or combinations thereof.

The alkyd resins of the present invention also include from about 25% to about 80%, or preferably from about 35% to about 70%, or more preferably from about 40% to about 60% of fatty acids, fatty acid derivatives of oils or a combination thereof. The fatty acids useful in the alkyds may include without limitation, anteisoarachadic, behenic, bosseopentaenoic, capric, caprylic, catalpic, eicosadienoic, eleostearic, erydiogenic, isomargaric, isomyristic, jacaric, lauric, lesquerolic, licanic, linoleic, linolenic, myristic, oleic, palmitic, parinaric, punicic, ricinoleic, ricinenic, rumenic, rumelenic, stearic acids, synthetic fatty acids or mixtures thereof. Fatty acid derivatives of oils useful in the present alkyds include, without limitation, derivatives of linseed oil, soybean oil, dehydrated castor oil, raw castor oil, lesquerella oil, peanut oil, tall oil, tung oil, fish oil, sunflower oil, safflower oil, cottonseed oil, rapeseed oil, olive oil, coconut oils, or combinations thereof.

The polyol-polyacid alkyd of the present invention may also be further chemically modified through reaction with acrylic monomers, isocyante, rosin or phenolic. More particularly, the polyol-polyacid alkyd can be chemically modified through reaction with at least one of the following reactants:

a′) acrylic and/or vinylic monomers, about 1% to about 60% by weight

b′) isocyanate, about 1% to about 40% by weight

c′) rosin, about 1% to about 20% by weight

d′) phenolic, about 1% to about 20% by weight

When the alkyd is modified by reaction with from about 1% to about 60%, by weight of the resin, with the acrylic and/or vinylic monomer, the acrylic and/or vinylic monomer may be selected from the group of butyl acrylate, methyl methacrylate, ethyl acrylate, 2-ethylhexylacrylate, methacrylamide, diacetone acrylamide, styrene, vinyl toluene and combinations thereof. When the polyol-polyacid alkyd is modified by reaction with from about 1% to about 40%, by weight of the resin with an isocyanate, the isocyanate may be selected from the group of toluene diisocyanate, isophorone diisocyanate, hexamethylene diisocyanate, methylene diphenyl diisocyanate, hydrogenated methylene diphenyl diisocyanate, or combinations thereof. The polyol-polyacid alkyd may be also chemically modified by reaction with rosin which may be used at about 1 % to about 20% by weight (of the polyol-polyacid alkyd), or it may be modified by phenolic at about 1% to about 20% by weight. When the polyol-polyacid alkyd resin is modified by rosin, the rosin may be selected from the group consisting of tall oil rosin, gum rosin, brazil gum rosin, maleic modified rosin and combinations thereof, and when it is modified by phenolic, the phenolic may be selected from heat reactive phenolic, non-heat reactive phenolic, and combinations thereof.

The polyol-polyacid alkyd of the present alkyd resin may also be chemically modified through reaction with hydroxy-functional or methoxy functional silicone resin accounting for up to about 60% by weight of the alkyd resin composition.

The components of the alkyd are polymerized in the desired ratios to achieve a weight average molecular weight of from about 30,000 to about 80,000 Daltons.

Conventional alkyds are diluted with solvent to a level of about 45% to about 60% solids as supplied to customers. However, it is these VOC solvents that are the subject of regulatory attention. In one aspect, the needs for these VOC solvents may be minimized by the use of the highly esterified polyol polyester of the present invention.

According to a specific embodiment, the alkyd resin of the present invention comprises, besides the polyol-polyacid alkyd A) as defined above, a composition B) comprising at least two (two or more) highly esterified polyol polyesters as defined above.

Another embodiment of the present invention relates to a coating composition comprising:

i) at least one alkyd resin as defined according to the present invention,

ii) one or more driers, and

iii) optionally, one or more pigments,

iv) optionally, at least one solvent, and

v) optionally, at least one rheological modifier.

More particularly, in the coating composition, the alkyd resin may be present at 10-80% by weight of the coating composition. The active component of the drier may be present at 0.001-0.6% by weight of the coating composition, the pigment may be present at 0-80%, the solvent at 0-80%, and the rheological modifier at 0-20% by weight of the coating composition. Preferably the coating composition is a paint composition and more particularly a low VOC and low viscosity paint composition. The paint composition is distinguished by its controlled drying.

The alkyd resin containing the polyol polyester as defined above according to the present invention, may be used in coatings compositions and more particularly in basic paint compositions. In a paint composition, the alkyd resin may be combined with pigment, driers, crosslinkers, and other additives to produce a paint product. The alkyd resin composition of the present invention provides a preferred low VOC, and a low viscosity base for making paint with controlled drying character.

The alkyd resin composition of the present invention may be used in coating compositions. More particularly, it may be used in an aqueous alkyd dispersion for aqueous coating compositions based on alkyds. The coating compositions may comprise the alkyd resin of the present invention, one or more driers, optionally one of more pigments, one or more solvents or rheological modifiers. The coating compositions may comprise from about 10% to about 80%, by weight of the coating composition, of the alkyd resin. The coating compositions may comprise from about 0.001% to about 0.6%, by weight of the coating composition, of a drier known in the art. These driers include, without limitation, cobalt, zirconium, manganese and calcium. The coating compositions may optionally contain up to about 80%, by weight of the coating composition, of one or more pigments. The coating compositions may optionally contain 0-80% or up to about 80%, by weight of the liquid coating, of a solvent. The coating composition may also optionally contain up to 20% by weight of the coating composition of a Theological modifier.

Finally, the present invention relates to the use of a highly esterified polyester polyol composition as defined according to composition B, as disclosed above as a non-volatile, low VOC, low viscosity component, more particularly in alkyds, including alkyds dispersions, and in coatings compositions including non-aqueous and aqueous coatings compositions.

### Analytical Methods

### Ester Distribution of Sucrose Polyester via HPLC

The relative distribution of the individual octa-, hepta-, hexa-, penta-, as well as collectively the tetra through mono-esters, of the sucrose polyester can be determined using normal-phase high performance liquid chromatography (HPLC). A silica gel-packed column is used in this method to separate the polyester sample into the respective ester groupings noted above. Hexane and methyl-t-butyl ether are used as the mobile phase solvents. The ester groupings are quantified using a mass detector (i.e. an evaporative light-scattering detector). The detector response is measured and then normalized to 100%. The individual ester groups are expressed as a relative percentage. Additional details related to the method are explained in U.S. Pat. No. 7,276,485 (Cerreta et al.).

### FTIR to Measure Reaction Completion (Acid Chloride Route)

The reaction completion of sucrose polyester made using the acid chloride route was determined using a Perkin Elmer, Spectrum One B, Fourier Transform Infra Red Spectrophotometer. A sample was taken, extracted into hexane, water washed, and then the hexane layer was separated and dried over MgSO₄. The dried hexane extract was then evaporated under a stream of nitrogen and analyzed by FTIR (placed between NaCl salt flats, no dilution). The reaction was considered to be complete when the hydroxyl peak (˜3480 cm-1) disappeared and the ester carbonyl (˜1730-50) was maximized.

### EXAMPLES

### Highly Esterified Polyol Polyesters

### Example 1

Sucrose Polyester made from Tung Oil Fatty Acid Methyl Ester

### Preparation of Tung Oil Fatty Acid Methyl Ester

6000 grams Tung Oil are transferred into a 12 L reaction flask assembled for reflux and equipped with the following; cold water condenser, overhead mechanical stirrer, temperature regulator, thermocouple, heating mantle, nitrogen inlet adapter and other misc. glassware adapters). 1530 grams anhydrous methanol and 30 grams of sodium methoxide are then added and the flask is placed under a slight nitrogen blanket to exclude atmospheric oxygen. The contents of the flask are heated to reflux and the reaction is continued to completion as monitored by HPLC (High Performance Liquid Chromatography). Upon reaction completion, the contents of the flask are allowed to cool without stirring until a distinct glycerol layer has separated to the bottom of the flask. The glycerol layer is removed and the oil layer is then water washed several times until the water layer is neutral to pH paper. The water layer is removed and the oil layer is then dried at 110° C. with a constant nitrogen sparge. The DCO fatty acid methyl esters are then additionally purified by vacuum distillation yielding a clear, slightly yellow tinged liquid.

### Preparation of Tung Oil Sucrose Polyester

387 grams of fatty acid methyl ester made from Tung Oil are transferred into a 5 L reaction flask along with 15.2 grams potassium stearate, 89.6 grams sucrose and 3.4 grams potassium carbonate. The reaction flask is assembled for distillation, and equipped with the following; cold water condenser, overhead mechanical stirrer, temperature regulator, thermocouple, nitrogen sparge tube, heating mantle, receiving flask, dry ice condenser and misc. glassware adapters. The contents of the flask are mixed with vigorous stirring while heating to 135° C. A nitrogen sparge tube is introduced beneath the liquid surface to assist with methanol removal and to drive the reaction to completion. After the mixture has reacted a few hours, the sucrose will be dissolved and the solution will become a clear, pale brown liquid. 2725 grams additional dehydrated castor oil fatty acid methyl ester are then added along with an additional 4.5 grams potassium carbonate and the reaction was continued at 135° C. until analysis by High Performance Liquid Chromatography (HPLC) indicated greater than about 50% conversion to sucrose octaester, or more preferably greater than about 60% sucrose octaester. The contents of the flask are then cooled to 75° C. and approximately 10% water (by weight of batch) is added with gentle mixing. The agitation is then stopped and the hydrated soap is allowed to settle and removed. The oil layer is then water washed, the water layer removed and the oil layer dried under vacuum (70-90° C., ˜30 mm Hg pressure). The dried oil layer is then mixed with approximately 1% TriSyl bleaching aid for 15 min. at 90° C. The bleaching aid is then removed by pressure filtration. The crude sucrose polyester is then passed through a wiped film evaporator to remove the excess dehydrated castor oil fatty acid methyl esters. The finished DCO sucrose polyester is then placed into clean glass jars, blanketed with nitrogen, sealed and stored at 4.4° C. (40° F.).

### Example 2-4

Sucrose Polyester made from Blended Tung and Soy Fatty Acid Methyl Ester

Both tung oil and soybean oil fatty acid methyl ester are made separately, according to the procedure outlined in Example 1. The purified fatty acid methyl esters are then blended to make the following methyl ester mixture; 25% Tung FAME/75% Soy FAME (by weight).

Sucrose Polyester made from Blended Methyl Esters 25% Tung FAME/75% soy FAME

409 grams of fatty acid methyl ester made from blended methyl esters (25% Tung/75% Soy) are transferred into a 12 L reaction flask along with 16 grams potassium stearate, 94 grams sucrose and 3.8 grams potassium carbonate. The reaction flask is assembled for distillation, and equipped with the following; cold water condenser, overhead mechanical stirrer, temperature regulator, thermocouple, nitrogen sparge tube, heating mantle, receiving flask, dry ice condenser and misc. glassware adapters. The contents of the flask are mixed with vigorous stirring while heating to 135° C. A nitrogen sparge tube is introduced beneath the liquid surface to assist with methanol removal and to drive the reaction to completion. After the mixture has reacted a few hours, the sucrose has dissolved and the solution becomes a clear, pale brown liquid. 4087.5 grams additional blended fatty acid methyl ester are then added along with an additional 6.8 grams potassium carbonate and the reaction is continued at 135° C. until analysis by High Performance Liquid Chromatography (HPLC) indicates greater than about 50% conversion to sucrose octaester, or more preferably greater than about 60% sucrose octaester. The contents of the flask are then cooled to about 75° C. and about 10% water (by weight of batch) is added with gentle mixing. The agitation is then stopped and the hydrated soap allowed to settle and removed. The oil layer is then water washed, the water layer removed and the oil layer dried under vacuum at a temperature of about 70° C. to about 90° C. at approximately 30 mm Hg pressure. The dried oil layer is then mixed with approximately 1% TriSyl bleaching aid for about 15 minutes at approximately 90° C. The bleaching aid is then removed by pressure filtration. The crude sucrose polyester is then passed through a wiped film evaporator to remove the excess fatty acid methyl esters. The finished Tung Oil/Soy Oil sucrose polyester is then placed into clean glass jars, blanketed with nitrogen, sealed and stored at 4.4° C. (40° F.).

### Example 3

Example 2 is repeated except that the fatty acid methyl esters are blended to the following mixture; about 15% Tung FAME/about 85% Soy FAME. The sucrose polyester is then made using the blended methyl esters as described in example 2.

### Example 4

Example 2 is repeated except that the fatty acid methyl esters are blended to the following mixture; about 10% Tung FAME/about 90% Soy FAME. The sucrose polyester is then made using the blended methyl esters as described in example 2.

### Example 5

Sucrose Polyester made from blended Linseed Oil FAME and Soy FAME.

Linseed oil fatty acid methyl ester is made according to the procedure outlined in example 1. The linseed oil FAME is then blended with Soy FAME in the following mixture; 75% linseed oil FAME/25% Soy FAME.

Preparation of sucrose polyester from the blended Linseed Oil FAME and Soy FAME are made following the procedure outlined in example 1.

### Example 6

Sucrose Polyester made from Tung Oil Fatty Acid Methyl Esters using a Solvent Process

2000 grams Tung Oil FAME are added to a 12 L reaction flask along with about 5600 grams N,N-dimethylacetamide, about 190 grams sucrose, and about 38 grams potassium carbonate. The reaction flask is assembled for distillation with the following; cold water condenser, overhead mechanical stirrer, temperature regulator, thermocouple, heating mantle, nitrogen inlet adapter, receiving flask, dry ice condenser, vacuum pump, manometer, and misc. glassware adapters. The flask is evacuated to approximately 20 mm Hg pressure, stirred vigorously and heated to approximately 120° C. The reaction is continued until greater than about 60% sucrose octaester as analyzed by HPLC. The crude reaction mix is then evaporated under full vacuum to remove any remaining solvent. The crude Tung sucrose polyester is then mixed with 1% by weight TriSyl bleaching aid at about 90° C. The bleaching aid is removed by pressure filtration and the excess methyl esters are distilled by passing the product through a wiped film evaporator. The finished Tung sucrose polyester is then placed into clean jars, blanketed with nitrogen, sealed and placed in storage at 4.4° C. (40° F.).

### Example 7

Sucrose Polyester made from Tung Fatty Acid Chloride

Tung Oil Fatty Acid Methyl Ester is converted to fatty acid. The Tung fatty acid is then used to make sucrose polyester via the acid chloride route. 2000 grams Tung fatty acid are dissolved into about 4L methylene chloride. The solution is transferred into a 12L reaction flask assembled for reflux with the following; cold water condenser, overhead mechanical stirrer, temperature regulator, thermocouple, nitrogen inlet adapter, addition funnel, and other misc. glassware adapters. 920 grams oxalyl chloride are then carefully weighed out, diluted with 600 mls methylene chloride and transferred into an addition funnel positioned over the reaction flask. A slight, constant nitrogen flow is swept through the reactor headspace to exclude oxygen. The oxalyl chloride is then slowly added to the reaction flask with stirring at room temperature. It is important to add the oxalyl chloride very slowly to control the evolution of gas that is formed as the fatty acid is converted to fatty acid chloride. Upon complete addition of the oxalyl chloride, the reaction is allowed to continue at room temperature until all of the fatty acid carbonyl is converted to fatty acid chloride as monitored by FTIR. The Tung fatty acid chloride is the evaporated using a rotary evaporator.

500 grams of Tung fatty acid chloride are weighed out and diluted with about500 mls methylene chloride. 45 grams sucrose are transferred into a 5 L reaction flask (assembled for reflux) along with 300 mls N,N-dimethylformamide and 600 mls pyridine. The sucrose solution is stirred at 60° C. until dissolved and then cooled to approximately 30° C.; a very slight but constant nitrogen flow is swept through the reactor headspace. The Tung fatty acid chloride solution is then transferred into an addition funnel positioned over the reaction flask and slowly added to the stirring sucrose solution. The reaction is allowed to continue at approximately 40° C. until the hydroxyl peak disappeared when analyzed by FTIR. The solution is then water washed several times, the organic layer separated and then dried over anhydrous magnesium sulfate. The solutions are then filtered to remove the MgSO₄ and evaporated to dryness using a rotary evaporator. The crude Tung sucrose polyester is then extracted 3 times with hot methanol to remove any residual fatty acid or fatty acid chloride that remains. The Tung sucrose polyester is then heated to about 100° C. under full vacuum (<2 mm Hg) to remove trace solvent, transferred into clean jars, blanketed with nitrogen and stored at 4.4° C. (40° F.).

### Paints and Resins

### Examples 8A-E

### Alkyd Resins

A soya long oil alkyd resin (available from Cook Composites and Polymers, CHEMPOL® 801-2426) is used in the evaluation of various sucrose polyesters. The soya long oil alkyd resin meets Federal specification TT-R-226(d), type 1, class A, and contains 30% mineral spirits, at least 23% by weight phthalic anhydride, and oil length of 60% to 65%. The soya long oil alkyd resin has an acid number of 5-10 and a Y-Z2 Gardner-Holdt viscosity. The dry time to touch is less than 4 hours, and the hard dry time is less than 7 hours determined by ASTM D1640. The VOC content is determined per US EPA method 24. The MEK double rubs (CCP-22-PRL-TM-0820) is used to assess the MEK resistance of various coatings.

The following alkyd resins are prepared.

| 8A | control | soya long oil alkyd 70% solids CHEMPOL ® 801-2426 |
|---|---|---|
| 8B | 60/40 | 8012426/Sucrose Polyester - Soybean Oil Esters |
| 8C | 60/40 | 8012426/Sucrose Polyester - 85% Soybean Oil/15% |
| | | Tung Oil Esters |
| 8D | 60/40 | 8012426/Sucrose Polyester - Tung Oil Esters |
| 8E | 60/40 | 8012426/Sucrose Polyester - Dehydrated Castor Oil Esters |

Resins 8B-8E are 85% solids in mineral spirits.

### Clear Resin Examples

### Examples 9A-E

| | | 9B-E (Each are |
|---|---|---|
| | | made with corresponding |
| PBW | 9A | alkyd resin 8A-E) |
| Alkyd resin | 128.6 | 105.9 |
| Mineral spirits | — | 22.7 |
| 12% cobalt drier | 0.5 | 0.5 |
| 5% calcium drier | 1.8 | 1.8 |
| 12% zirconium drier | 1.5 | 1.5 |
| Anti-skin | 0.2 | 0.2 |
| Activ-8 | 0.6 | 0.6 |

### White Paint Examples

### Examples 10A-E

| | | 10B-D (Each are made with | |
|---|---|---|---|
| | | corresponding alkyd | |
| PBW | 10A | resin 8A-E) | |
| Alkyd resin | 128.6 | 100.0 | |
| Mineral spirits | 50.0 | 55.0 | |
| Organoclay thixotrope | 5.0 | 5.0 | Crayvallac OC-150 |
| Byk P104 | 4.0 | 4.0 | pigment dispersant |
| Titanium dioxide | 400.0 | 400.0 | TiPure ® R902 |
| Lampblack | 0.1 | 0.1 | Elementis LB1011 |

High speed Cowles disperse 15 minutes, and let down with

| | | |
|---|---|---|
| Alkyd resin | 200.0 | 200.0 |
| Mineral spirit | 20.0 | 20.0 |

Take above reduced grind paste and let down further into

| | | |
|---|---|---|
| Alkyd resin | 300.0 | 200.0 |

Continue let down

| | | | |
|---|---|---|---|
| Alkyd resin, adjusting | 50.4 | 59.2 | |
| 12% cobalt drier | 2.8 | 2.8 | |
| 5% calcium drier | 9.5 | 9.5 | |
| 12% zirconium drier | 8.0 | 8.0 | |
| Anti-skin | 2.1 | 2.1 | |
| Activ-8 | 3.0 | 3.0 | |
| Mineral spirits | 73.6 | 33.7 | viscosity adjust |
| % solids | 71.1 | 81.2 | |

As used herein, the term “comprising” means various components conjointly employed in the preparation of the compositions of the present disclosure. Accordingly, the terms “consisting essentially of” and “consisting of” are embodied in the term “comprising”.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

What is claimed is:

1. An alkyd resin comprising:
A) a polyol-polyacid alkyd; and
B) a composition comprising a highly esterified polyol polyester wherein the polyester comprises a polyol residue and a plurality of fatty acids esters, and wherein from about 2% to about 55% of the fatty acid esters contains two or more pairs of conjugated double bonds.

2. The alkyd resin according to claim 1, wherein the polyol-polyacid alkyd is a reaction product of:
a) from about 10% to about 40% by weight of a polyol;
b) from 0 to about 40%,by weight of a polyacid, an acid anhydride or combination thereof; and
c) from about 25% to about 80% by weight of a fatty acid, fatty acid derivative of oil, or combination thereof.

3. The alkyd resin according to claim 2 wherein the polyol is selected from the group consisting of glycerol, pentaerythritol, dipentaerythritol, trimethylolethane, trimethylolpropane, ethylene glycol, propylene glycol, neopentylene glycol and dipropylene glycol and combinations thereof.

4. The alkyd resin according to claim 2, wherein the polyacid or acid anhydride component is selected from the group consisting of isophthalic acid, terephthalic acid, chlorendic anhydride, tetrahydrophthalic anhydride, hexa hydrophthalic anhydride, phthalic anhydride, maleic anhydride, fumaric acid, chlorendic anhydride, azelaic acid, succinic acid, adipic acid, sebacic acid and combinations thereof.

5. The alkyd resin according to claim 2, wherein the fatty acid is selected from the group consisting of anteisoarachadic, behenic, bosseopentaenoic, capric, caprylic, catalpic, eleostearic, erydiogenic, isomargaric, isomyristic, jacaric, lauric, licanic, linoleic, linolenic, myristic, oleic, palmitic, parinaric, punicic, ricinoleic, rumenic, rumelenic, stearic acids and mixtures thereof.

6. The alkyd resin according to claim 2, wherein the fatty acid derivatives of oils are selected from the group consisting of linseed, soybean, dehydrated castor, raw castor, peanut, tall, tung, fish, sunflower, safflower, cottonseed, rapeseed oil, olive oil, coconut oils, naturally occurring oils synthetic fatty acids derived from oils, or combinations thereof.

7. The alkyd resin according to claim 1, wherein the polyol-polyacid alkyd is chemically modified through reaction with at least one of the following reactants:
a′) at least one of an acrylic monomer or a vinylic monomer at about 1% to about 60% by weight;
b′) isocyanate at about 1% to about 40% by weight;
c′) rosin at about 1% to about 20% by weight; and
d′) phenolic at about 1% to about 20% by weight.

8. The alkyd resin according to claim 7, wherein the acrylic monomer or vinylic monomer is selected from the group consisting of butyl acrylate, methyl methacrylate, ethyl acrylate, 2-ethylhexylacrylate, methacrylamide, diacetone acrylamide, styrene, vinyl toluene and combinations thereof.

9. The alkyd resin according to claim 7, wherein the isocyanate is selected from the group consisting of toluene diisocyanate, isophorone diisocyanate, hexamethylene diisocyanate, methylene diphenyl diisocyanate, hydrogenated methylene diphenyl diisocyanate, and combinations thereof.

10. The alkyd resin according to claim 7, wherein the polyol-polyacid alkyd resin is modified by rosin selected from the group consisting of tall oil rosin, gum rosin, brazil gum rosin, maleic modified rosin and combinations thereof, or modified by phenolic selected from the group consisting of heat reactive phenolic, non-heat reactive phenolic, and combinations thereof.

11. The alkyd resin according to claim 1, wherein the polyol-polyacid alkyd is chemically modified through reaction with hydroxy-functional or methoxy-functional silicone resin up to about 60% by weight of the reaction product.

12. The alkyd resin according to claim 1, wherein the polyol residue of the polyol polyester is a residue of a polyol selected from the group consisting of sugars, sugar alcohols, and mixtures thereof.

13. The alkyd resin according to claim 12, wherein the polyol residue is a residue of a polyol selected from the group consisting of adonitol, arabitol, sorbitol, mannitol, galactitol, isomalt, lactitol, xylotol, maltitol, 1-methyl-glucopyranoside, 1-methyl-galactopyranoside, 1-methyl-mannopyranoside, dextrin, erythritol, pentaerythritol, diglycerol, polyglycerol, sucrose, amylose, nystose, kestose, trehalose, raffinose, gentianose and mixtures thereof.

14. The alkyd resin according to claim 12, wherein the highly esterified polyol polyester has an average esterification of the available hydroxyl groups of at least 50%, with one or more fatty acids selected from the group consisting of anteisoarachadic, behenic, bosseopentaenoic acid, calendic capric, caprylic, catalpic, eicosadienoic, eleostearic, erydiogenic, isomargaric, isomyristic, isostearic, jacaric, lauric, lesquerolic, licanic, linoleic, linolenic, myristic, oleic, palmitic, parinaric, punicic, ricinoleic, rumenic, ricinenic, rumelenic, and stearic acids.

15. The alkyd resin according to claim 14, wherein the one or more fatty acids are selected from the group consisting of stearic acid, oleic acid, linoleic acid, linolenic acid, ricinoleic acid, calendic acid, jacaric acid, catalpic acid, eleostearic acid, punicic acid, parinaric acid, and bosseopentaenoic acid, and mixtures thereof.

16. The alkyd resin according to claim 14, wherein the fatty acids comprise from about 2% to about 20% of an eleostearic acid.

17. An alkyd resin according to claim 1, wherein the polyol polyester composition B) comprises two or more, highly esterified polyol polyesters.

18. A coating composition, comprising:
i) at least one alkyd resin comprising:
A) a polyol-polyacid alkyd; and
B) a composition comprising a highly esterified polyol polyester wherein the polyester comprises a polyol residue and a plurality of fatty acids esters, and wherein from about 2% to about 55% of the fatty acid esters contains two or more pairs of conjugated double bonds;
ii) one or more driers;
iii) optionally, one or more pigments;
iv) optionally, at least one solvent; and
v) optionally, at least one rheological modifier.

19. The coating composition according to claim 18, wherein the alkyd resin is about 10-80% by weight of the coating composition.

20. The coating composition according to claim 18, wherein an active component of the drier is about 0.001-0.6% by weight of the coating composition.

21. The coating composition according to claim 18, wherein the pigment is about 0-80% by weight of the coating composition.

22. The coating composition according to claim 18, wherein, the solvent is about 0-80% by weight of the coating composition.

23. The coating composition according to claim 18, wherein the Theological modifier is about 0-20% by weight of the coating composition.

24. The coating composition according to claim 18, wherein the composition is a paint composition.

25. A non-volatile, low-VOC, low viscosity component, comprising:
a composition comprising a highly esterified polyol polyester wherein the polyester comprises a polyol residue and a plurality of fatty acids esters, and wherein from about 2% to about 55% of the fatty acid esters contains two or more pairs of conjugated double bonds.

26. The component according to claim 25, in an alkyd composition.

27. The component according to claim 26, wherein the alkyd composition is an alkyd dispersion or a coating composition.

28. A method of producing an alkyd composition, comprising:
adding to an alkyd composition, a non-volatile, low-VOC, low viscosity component comprising a composition comprising a highly esterified polyol polyester wherein the polyester comprises a polyol residue and a plurality of fatty acids esters, and wherein from about 2% to about 55% by weight of the fatty acid esters contains two or more pairs of conjugated double bonds;

29. The method according to claim 28, wherein the alkyd composition is an alkyd dispersion or a coating composition.
